(19) United States
(12) Patent Application Publication
(10) Pub. No.: US 2018/0232803 A1
(43) Pub. Date: Aug. 16, 2018

(54) CONTRACT MANAGEMENT SYSTEM AND METHOD

(71) Applicant: MonetaGo Inc., New York, NY (US)

(72) Inventor: Brendan L. Taylor, New York, NY (US)

(21) Appl. No.: 15/895,454

(22) Filed: Feb. 13, 2018

Related U.S. Application Data
(60) Provisional application No. 62/458,799, filed on Feb. 14, 2017.

(51) Int. Cl. G06Q 40/02; G06Q 50/18

(52) U.S. Cl. CPC G06Q 40/02; G06Q 50/18

(57) ABSTRACT

A computer-implemented method, computer program product and computing system for defining one or more smart contracts between various member banks associated with a central bank. A select contract, chosen from the one or more smart contracts, is replaced with a successor contract. Access is granted to data associated with the select contract to the successor contract.

### RELATED APPLICATION(S)

This application claims the benefit of U.S. Provisional Application No. 62/458,799, filed on 14 Feb. 2017, the entire contents of which are incorporated herein by reference.

### TECHNICAL FIELD

This disclosure relates to settlement systems and, more particularly, to settlement systems that utilize a ledger system.

### BACKGROUND

Businesses function in a global economy and assets are often transferred between these companies. Accordingly, a first company may invoice a second company, wherein payments may be made by transferring assets (e.g., funds) from a bank account of the second company to a bank account of the first company, wherein these transfers may be processed using various settlement systems.

As these settlement systems evolve to use distributed ledger systems to track and monitor such transfers, what was once a tightly & centrally controlled system has transformed into a system that is ruled by committee and consensus. Unfortunately, while such systems sound democratic and egalitarian, the actual implementation of these systems often result in slow operations/gridlock and administrative headaches.

### SUMMARY OF DISCLOSURE

In one implementation, a computer-implemented method for effectuating one or more asset transfers is executed on a computing device and includes defining one or more smart contracts between various member banks associated with a central bank. A select contract, chosen from the one or more smart contracts, is replaced with a successor contract. Access is granted to data associated with the select contract to the successor contract.

One or more of the following features may be included. The one or more smart contracts may include a plurality of two-party smart contracts between unique pairs of the various member banks. The one or more smart contracts may include a single multi-party smart contract between all of the various member banks. One or more asset transfers between the various member banks associated with the central bank may be processed. The one or more asset transfers may be settled. Settling the one or more asset transfers may include updating at least one distributed ledger to memorialize the settlement of the one or more asset transfers via the central bank. The at least one distributed ledger may include a blockchain ledger. Updating at least one distributed ledger to memorialize the settlement of the one or more asset transfers via the central bank may include updating a distributed ledger associated with each of the various member banks to memorialize the settlement of the one or more asset transfers via the central bank. The successor contract may be replaced with a subsequent contract. Access to data associated with the successor contract may be granted to the subsequent contract.

In another implementation, a computer program product resides on a computer readable medium and has a plurality of instructions stored on it. When executed by a processor, the instructions cause the processor to perform operations including defining one or more smart contracts between various member banks associated with a central bank. A select contract, chosen from the one or more smart contracts, is replaced with a successor contract. Access is granted to data associated with the select contract to the successor contract.

One or more of the following features may be included. The one or more smart contracts may include a plurality of two-party smart contracts between unique pairs of the various member banks. The one or more smart contracts may include a single multi-party smart contract between all of the various member banks. One or more asset transfers between the various member banks associated with the central bank may be processed. The one or more asset transfers may be settled. Settling the one or more asset transfers may include updating at least one distributed ledger to memorialize the settlement of the one or more asset transfers via the central bank. The at least one distributed ledger may include a blockchain ledger. Updating at least one distributed ledger to memorialize the settlement of the one or more asset transfers via the central bank may include updating a distributed ledger associated with each of the various member banks to memorialize the settlement of the one or more asset transfers via the central bank. The successor contract may be replaced with a subsequent contract. Access to data associated with the successor contract may be granted to the subsequent contract.

In another implementation, a computing system including a processor and memory is configured to perform operations including defining one or more smart contracts between various member banks associated with a central bank. A select contract, chosen from the one or more smart contracts, is replaced with a successor contract. Access is granted to data associated with the select contract to the successor contract.

One or more of the following features may be included. The one or more smart contracts may include a plurality of two-party smart contracts between unique pairs of the various member banks. The one or more smart contracts may include a single multi-party smart contract between all of the various member banks. One or more asset transfers between the various member banks associated with the central bank may be processed. The one or more asset transfers may be settled. Settling the one or more asset transfers may include updating at least one distributed ledger to memorialize the settlement of the one or more asset transfers via the central bank. The at least one distributed ledger may include a blockchain ledger. Updating at least one distributed ledger to memorialize the settlement of the one or more asset transfers via the central bank may include updating a distributed ledger associated with each of the various member banks to memorialize the settlement of the one or more asset transfers via the central bank. The successor contract may be replaced with a subsequent contract. Access to data associated with the successor contract may be granted to the subsequent contract.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a settlement process according to an embodiment of the present disclosure;

FIG. 2 is a flowchart of an implementation of the settlement process of FIG. 1 according to an embodiment of the present disclosure; and

FIG. 3 is a diagrammatic view of a plurality of smart contracts according to an embodiment of the present disclosure.

Like reference symbols in the various drawings indicate like elements.

### DETAILED DESCRIPTION OF THE PREFERRED EMBODIMENTS

System Overview

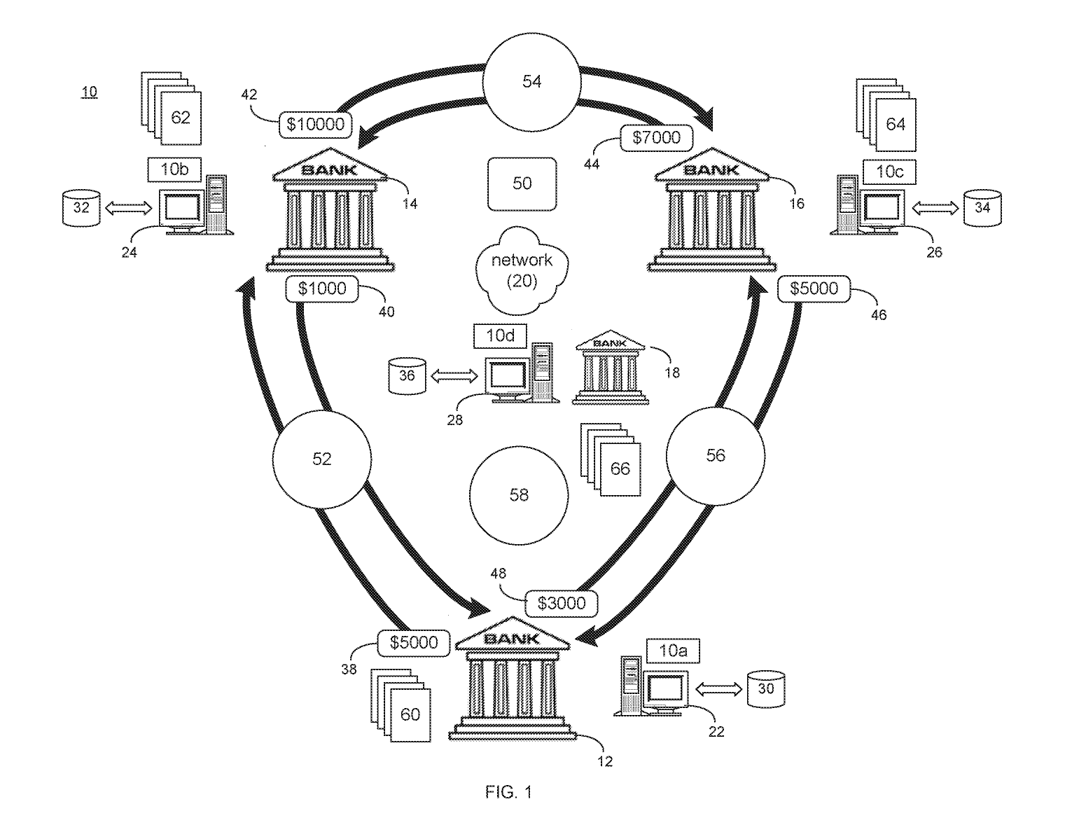

Referring to FIG. 1, there is shown settlement process 10. As will be discussed below in greater detail, settlement process 10 may be configured to effectuate a settlement between a plurality of banks. Examples of such a plurality of banks may include but are not limited to commercial bank 12, commercial bank 14 and commercial bank 16.

For this example, assume that central bank 18 is associated with commercial bank 12, commercial bank 14 and commercial bank 16. Accordingly, central bank 18 may be configured to effectuate settlement of exchanges between member banks (e.g., commercial banks 12, 14, 16). As is known in the art, a central bank (e.g., central bank 18) may be a monetary authority (e.g., a monopolized or nationalized institution) that controls the production and distribution of money and credit. In modern economies, a central bank (e.g., central bank 18) may be responsible for the formulation of monetary policy and the regulation of member banks (e.g., commercial banks 12, 14, 16). Assuming that commercial banks 12, 14, 16 (in this example) are US-based commercial banks, and an example of central bank 18 may include the United States Federal Reserve System, wherein central bank 18 may be configured to effectuate account-based transfers between member banks (e.g., commercial banks 12, 14, 16). Specifically, central bank 18 may be configured to maintain individual accounts for member banks (e.g., commercial banks 12, 14, 16), wherein asset transfers (e.g., in US dollars) from one member bank to another member bank may be effectuated by debiting the account of the transferring member bank a defined quantity of US dollars and crediting the account of the receiving member bank the same defined quantity of US dollars.

Settlement process 10 may be implemented on a plurality of discrete computing devices via distributed computing network (e.g., network 20). Examples of network 20 may include but are not limited to the Internet, a local area network, or a wide area network. Network 20 may be connected to one or more secondary networks (not shown) or may be a portion of a larger network.

For this example and for illustrative purposes only, settlement process 10 is shown to be implemented on four computing devices (e.g., computing devices 22, 24, 26, 28) that are coupled via network 20, wherein each of computing devices 22, 24, 26, 28 may implement some or all of settlement process 10. Examples of computing devices 22, 24, 26, 28 may include, but are not limited to: a personal computer, a laptop computer, a notebook computer, a personal digital assistant, a smartphone, a server computer, a series of server computers, a mini computer, a mainframe computer, or a cloud-based computing network.

While in this particular example, settlement process 10 is shown to be implemented on four computing devices (e.g., computing devices 22, 24, 26, 28), this is for illustrative purposes only and is not intended to be a limitation of this disclosure, as other configurations are possible. For example, it is understood that the number of computing devices that implement settlement process 10 may be increased or decreased depending upon the specific needs, specific requirements and/or design criteria of settlement process 10.

Continuing with the above-stated example:
computing device 22 may implement a portion of settlement process 10 (e.g., settlement process 10a), wherein the instruction sets and subroutines of settlement process 10a, which may be stored on storage device 30 coupled to computing device 22, may be executed by one or more processors (not shown) and one or more memory architectures (not shown) included within computing device 22;
computing device 24 may implement a portion of settlement process 10 (e.g., settlement process 10b), wherein the instruction sets and subroutines of settlement process 10b, which may be stored on storage device 32 coupled to computing device 24, may be executed by one or more processors (not shown) and one or more memory architectures (not shown) included within computing device 24;
computing device 26 may implement a portion of settlement process 10 (e.g., settlement process 10c), wherein the instruction sets and subroutines of settlement process 10c, which may be stored on storage device 34 coupled to computing device 26, may be executed by one or more processors (not shown) and one or more memory architectures (not shown) included within computing device 26; and
computing device 28 may implement a portion of settlement process 10 (e.g., settlement process 10d), wherein the instruction sets and subroutines of settlement process 10d, which may be stored on storage device 36 coupled to computing device 28, may be executed by one or more processors (not shown) and one or more memory architectures (not shown) included within computing device 28.

Examples of storage devices 30, 32, 34, 36 may include but are not limited to: a hard disk drive; a RAID device; a random access memory (RAM); a read-only memory (ROM); and all forms of flash memory storage devices. Computing devices 22, 24, 26, 28 may each execute an operating system, examples of which may include but are not limited to Microsoft Windows™, Android™, WebOS™, iOS™, macOS™, Redhat Linux™, or a custom operating system.

The various computing devices (e.g., computing devices 22, 24, 26, 28) may be directly or indirectly coupled to network 20. For example, one or more of computing devices 22, 24, 26, 28 may be directly coupled to network 20 via a hardwired connection between one or more of computing devices 22, 24, 26, 28 and network 20. Additionally, one or more of computing devices 22, 24, 26, 28 may be wirelessly coupled to network 20 via a wireless communication channel (not shown) established between one or more of computing devices 22, 24, 26, 28 and a cellular network/wireless access point (not shown), which may be directly coupled to network 20.

As discussed above, central bank 18 may be configured to maintain individual accounts for member banks (e.g., commercial banks 12, 14, 16), wherein asset transfers (e.g., in US dollars) from one member bank to another member bank may be effectuated by debiting the account of the transferring member bank a defined quantity of US dollars and crediting the account of the receiving member bank the same defined quantity of US dollars.

Settlement Process

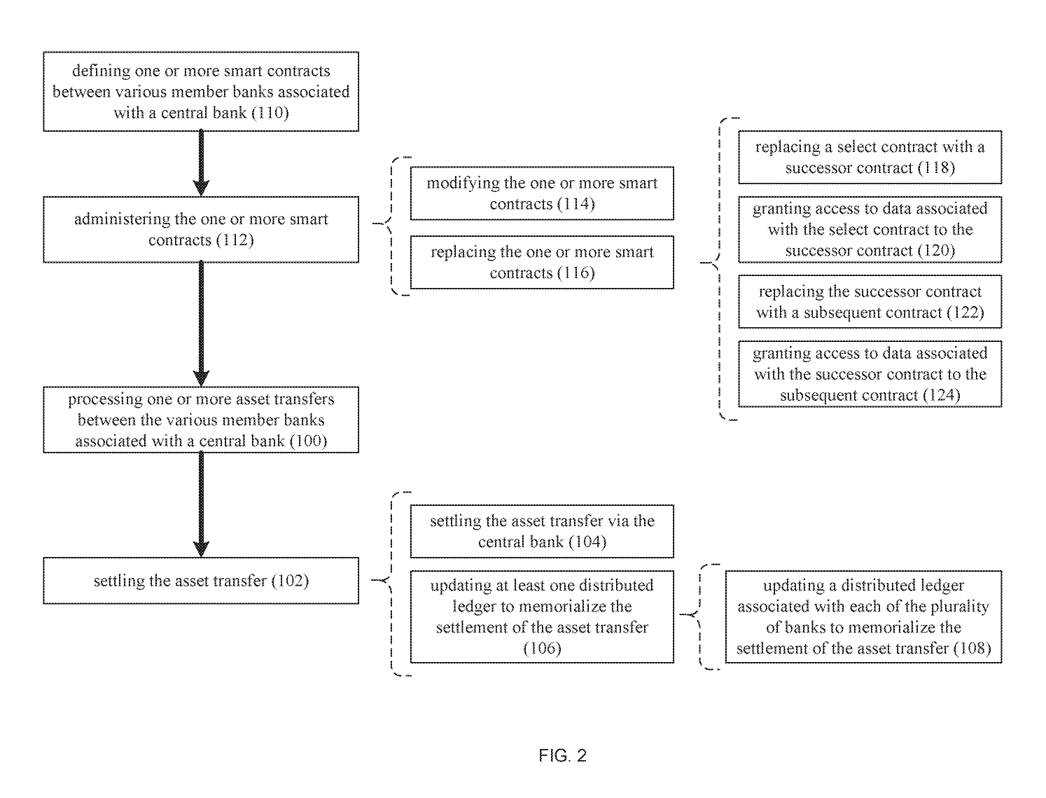

Referring also to FIG. 2, settlement process 10 may be configured to process 100 one or more asset transfers between the various member banks (e.g., commercial banks 12, 14, 16) associated with central bank 18 and may configured to settle 102 the one or more asset transfers. When settling 102 these asset transfers, settlement process 10 may settle 104 these asset transfers via central bank 18. For example:
commercial bank 12 may effectuate asset transfer 38 (e.g., $5,000) to commercial bank 14, resulting in central bank 18 debiting an account associated with commercial bank 12 by $5,000 and crediting an account associated with commercial bank 14 by $5,000;
commercial bank 14 may effectuate asset transfer 40 (e.g., $1,000) to commercial bank 12, resulting in central bank 18 debiting an account associated with commercial bank 14 by $1,000 and crediting an account associated with commercial bank 12 by $1,000;
commercial bank 14 may effectuate asset transfer 42 (e.g., $10,000) to commercial bank 16, resulting in central bank 18 debiting an account associated with commercial bank 14 by $10,000 and crediting an account associated with commercial bank 16 by $10,000;
commercial bank 16 may effectuate asset transfer 44 (e.g., $7,000) to commercial bank 14, resulting in central bank 18 debiting an account associated with commercial bank 16 by $7,000 and crediting an account associated with commercial bank 14 by $7,000;
commercial bank 16 may effectuate asset transfer 46 (e.g., $5,000) to commercial bank 12, resulting in central bank 18 debiting an account associated with commercial bank 16 by $5,000 and crediting an account associated with commercial bank 12 by $5,000; and
commercial bank 12 may effectuate asset transfer 48 (e.g., $3,000) to commercial bank 16, resulting in central bank 18 debiting an account associated with commercial bank 12 by $3,000 and crediting an account associated with commercial bank 16 by $3,000.

Net Settlement

While the above-described asset transfers (e.g., asset transfers 38, 40, 42, 44, 46, 48) may be settled 102 immediately and on an individual basis, settlement process 10 may settle 102 asset transfers (e.g., asset transfers 38, 40, 42, 44, 46, 48) in a deferred net fashion using a third party (e.g., clearing house 50). For example, clearing house 50 may monitor these asset transfers (e.g., asset transfers 38, 40, 42, 44, 46, 48) during a defined settlement period and then, after the expiry of this defined settlement period, the net value of these asset transfers (e.g., asset transfers 38, 40, 42, 44, 46, 48) may occur. Examples of such a settlement period may include but are not limited to a one hour period, a multi-hour period, a one day period, or a multi-day period.

As is known in the art, a clearing house (e.g., clearing house 50) may be a financial institution that facilitates the exchange (i.e., the clearance) of payments, securities, or derivatives transactions. Specifically, clearing house 50 may stand between (in this example) two commercial banks and may e.g., reduce the risk of one of these commercial banks failing to honor its settlement obligations after the expiry of the settlement period.

Assume that the settlement period is one day and the above-described asset transfers (e.g., asset transfers 38, 40, 42, 44, 46, 48) occur during such a one day settlement period. Accordingly, settlement process 10 may monitor these asset transfers (e.g., asset transfers 38, 40, 42, 44, 46, 48) and may then settle 102 (via clearing house 50) these asset transfers in a deferred net fashion. Accordingly:
Concerning Commercial Banks 12, 14: Commercial bank 12 effectuated asset transfer 38 (e.g., $5,000) to commercial bank 14 and commercial bank 14 effectuated asset transfer 40 (e.g., $1,000) to commercial bank 12, resulting in settlement process 10 settling 102 the asset transfer via a net asset transfer amount of $4,000 (i.e., $5,000-$1,000) from commercial bank 12 to commercial bank 14.
Concerning Commercial Banks 14, 16: Commercial bank 14 effectuated asset transfer 42 (e.g., $10,000) to commercial bank 16 and commercial bank 16 effectuated asset transfer 44 (e.g., $7,000) to commercial bank 14, resulting in settlement process 10 settling 102 the asset transfer via a net asset transfer amount of $3,000 (i.e., $10,000-$7,000) from commercial bank 14 to commercial bank 16.
Concerning Commercial Banks 16, 12: Commercial bank 16 effectuated asset transfer 46 (e.g., $5,000) to commercial bank 12 and commercial bank 12 effectuated asset transfer 48 (e.g., $3,000) to commercial bank 16, resulting in settlement process 10 settling 102 the asset transfer via a net asset transfer amount of $2,000 (i.e., $5,000-$3,000) from commercial bank 16 to commercial bank 12.

When settling 102 the above-described three net asset transfers, settlement process 10 may settle 104 these three net asset transfers via central bank 18. For example, once these net asset transfer amounts are determined (e.g., a net asset transfer of $4,000 from commercial bank 12 to commercial bank 14; a net asset transfer of $3,000 from commercial bank 14 to commercial bank 16; and a net asset transfer of $2,000 from commercial bank 16 to commercial bank 12), settlement process 10 may settle 104 these asset transfers by e.g., instructing central bank 18 to effectuate such asset transfers.

For example and when settling 102 the three net asset transfers, settlement process 10 may settle 104 these net asset transfers by providing instructions to central bank 18 to:
debit an account associated with commercial bank 12 by $4,000 while crediting an account associated with commercial bank 14 by $4,000;
debit an account associated with commercial bank 14 by $3,000 while crediting an account associated with commercial bank 16 by $3,000; and
debit an account associated with commercial bank 16 by $2,000 while crediting an account associated with commercial bank 12 by $2,000.

Ledgering:

When settling 102 asset transfers (e.g., asset transfers 38, 40, 42, 44, 46, 48), settlement process 10 may update 106 at least one distributed ledger (e.g., ledger 60, ledger 62, ledger 64 and/or ledger 66) to memorialize the settlement of the asset transfers (e.g., asset transfers 38, 40, 42, 44, 46, 48). One example of such a distributed ledger (e.g., ledger 60, ledger 62, ledger 64 and/or ledger 66) may include but is not limited to a blockchain ledger.

As is known in the art, a blockchain ledger may be a continuously growing list of records (e.g., called blocks) that are linked and secured using cryptography. For example, each block within a blockchain may contain a hash pointer as a link to a previous block. Accordingly, blockchains may be inherently resistant to modification of the data, as each block in the chain is linked (via a hash function) to the previous block in the chain. Accordingly, a block may include transaction data, a hash function that identifies the previous block in the blockchain ledger, and a time/date stamp. Functionally, a blockchain ledger may serve as an open, distributed ledger that may securely record transactions between two parties (e.g., commercial banks) efficiently and in a verifiable and permanent way.

As will be explained below in greater detail, when updating 106 at least one distributed ledger to memorialize the settlement of the asset transfers (e.g., asset transfers 38, 40, 42, 44, 46, 48), settlement process 10 may update 108 a distributed ledger associated with each of the plurality of banks (e.g., commercial banks 12, 14, 16) to memorialize the settlement of the asset transfers (e.g., asset transfers 38, 40, 42, 44, 46, 48).

For example and when updating 108 at least one distributed ledger (e.g., ledger 60, ledger 62, ledger 64 and/or ledger 66) to memorialize the settlement of the asset transfers (e.g., asset transfers 38, 40, 42, 44, 46, 48), settlement process 10 may update 108 each of ledger 60, ledger 62, ledger 64 and/or ledger 66 to reflect the above-described asset transfers (e.g., asset transfers 38, 40, 42, 44, 46, 48).

Specifically and if the above-described asset transfers (e.g., asset transfers 38, 40, 42, 44, 46, 48) are settled 102 immediately and on an individual basis, settlement process 10 may update 108 ledger 60, ledger 62, ledger 64 and/or ledger 66 to reflect the six above-described asset transfers (e.g., $5,000 from commercial bank 12 to commercial bank 14; $10,000 from commercial bank 14 to commercial bank 16; $5,000 from commercial bank 16 to commercial bank 12; $1,000 from commercial bank 14 to commercial bank 12; $7,000 from commercial bank 16 to commercial bank 14; and $3,000 from commercial bank 12 to commercial bank 16).

Further and if the above-described asset transfers (e.g., asset transfers 38, 40, 42, 44, 46, 48) are settled 102 in a deferred net fashion using a third party (e.g., clearing house 50), settlement process 10 may update 108 ledger 60, ledger 62, ledger 64 and/or ledger 66 to reflect the three above-described net asset transfers (e.g., $4,000 from commercial bank 12 to commercial bank 14; $3,000 from commercial bank 14 to commercial bank 16; and $2,000 from commercial bank 16 to commercial bank 12).

Continuing with the above-stated example, one or more of the following operations may be performed:
Settlement process 10 may update 108 ledgers 60, 62 to reflect the asset transfers between commercial bank 12 and commercial bank 14 by including one or more new blocks that include transaction data (e.g., the transfer amount(s), the transferor(s), and the transferee(s)), a time/date stamp for the transaction(s), and a copy of the hash of the previous block(s) in the blockchain ledger. Settlement process 10 may then generate a hash of these one or more new blocks for use within the next block in the blockchain.
Settlement process 10 may update 108 ledgers 62, 64 to reflect the asset transfers between commercial bank 14 and commercial bank 16 by one or more new blocks that include transaction data (e.g., the transfer amount(s), the transferor(s), and the transferee(s)), a time/date stamp for the transaction(s), and a copy of the hash of the previous block(s) in the blockchain ledger. Settlement process 10 may then generate a hash of these one or more new blocks for use within the next block in the blockchain.
Settlement process 10 may update 108 ledgers 64, 60 to reflect the asset transfers between commercial bank 16 and commercial bank 12 by including one or more new blocks that include transaction data (e.g., the transfer amount(s), the transferor(s), and the transferee(s)), a time/date stamp for the transaction(s), and a copy of the hash of the previous block(s) in the blockchain ledger. Settlement process 10 may then generate a hash of these one or more new blocks for use within the next block in the blockchain.
Settlement process 10 may update 108 ledger 66 to reflect the asset transfers between the commercial banks (e.g., commercial banks 12, 14, 16) by including one or more new blocks that include transaction data (e.g., the transfer amount(s), the transferor(s), and the transferee(s)), a time/date stamp for the transaction(s), and a copy of the hash of the previous block(s) in the blockchain ledger. Settlement process 10 may then generate hashes of these one or more new blocks for use within the next block in the blockchain.

As this is a distributed ledger system, a copy of the ledgers (e.g., ledgers 60, 62, 64, 66) may be calculated, verified and maintained by all interested parties (e.g., commercial banks 12, 14, 16 and central bank 18) on computing devices 22, 26, 24, 28 (respectively), wherein each of the interested parties (e.g., commercial banks 12, 14, 16 and central bank 18) must compare their newly-calculated blocks and confirm identical results before the newly-calculated blocks are added to (in this example) the other ledgers.

### Smart Contracts

When processing 100 the above-described asset transfers (e.g., asset transfers 38, 40, 42, 44, 46, 48) between the various member banks (e.g., commercial banks 12, 14, 16) associated with central bank 18, settlement process 10 may define 110 one or more smart contracts (e.g., smart contracts 52, 54, 56, 58) between various member banks (e.g., commercial banks 12, 14, 16) associated with central bank 18, wherein settlement process 10 may administer 112 these one or more smart contracts (e.g., smart contracts 52, 54, 56, 58).

As is known in the art, smart contracts (e.g., smart contracts 52, 54, 56, 58) may be computer protocols/algorithms intended to facilitate, verify and/or enforce the negotiation and/or performance of all or a portion of a contract. Accordingly and through the use of such smart contracts (e.g., smart contracts 52, 54, 56, 58), various contractual clauses may be made partially (or fully) self-executing and/or self-enforcing.

Often, the various parties in a transaction (e.g., commercial banks 12, 14, 16) may not know each other and may not trust each other. Accordingly, one or more smart contracts (e.g., smart contracts 52, 54, 56, 58) may be utilized to provide a higher level of security and trust when effectuating the above-described asset transfers (e.g., asset transfers 38, 40, 42, 44, 46, 48).

Smart contracts (e.g., smart contracts 52, 54, 56, 58) may be linked together so that the execution of one smart contract automatically triggers the execution of the other smart contracts (and vice versa). Accordingly, the presence of smart contracts (e.g., smart contracts 52, 54, 56, 58) may be known to (and reviewable by) settlement process 10. Therefore and prior to effecting any portion of the above-described transfers (e.g., asset transfers 38, 40, 42, 44, 46, 48), settlement process 10 may examine the smart contracts (e.g., smart contracts 52, 54, 56, 58) to ensure their presence and proper configuration.

Further and when processing asset transfers between the plurality of banks (e.g., commercial banks 12, 14, 16), settlement process 10 may utilize the smart contracts (e.g., smart contracts 52, 54, 56, 58) to ensure that all parties execute the transfers (e.g., asset transfers 38, 40, 42, 44, 46, 48) required to fully effectuate the same. Accordingly and through the use of smart contracts (e.g., smart contracts 52, 54, 56, 58), situations may be avoided where one commercial bank fails to effectuate their transfer.

Examples of these smart contracts may include but are not limited to: a) a plurality of two-party smart contracts (e.g., smart contracts 52, 54, 56) between unique pairs of the plurality of banks (e.g., commercial banks 12, 14, 16); and b) a single multi-party smart contract (e.g., smart contract 58) between all of the plurality of banks (e.g., commercial banks 12, 14, 16).

For this example and when a plurality of two-party smart contracts (e.g., smart contracts 52, 54, 56) are utilized, settlement process 10 may utilize a first smart contract (e.g., smart contract 52) to monitor and/or process asset transfers (e.g., asset transfers 38, 40) between commercial banks 12, 14; settlement process 10 may utilize a second smart contract (e.g., smart contract 54) to monitor and/or process asset transfers (e.g., asset transfers 42, 44) between commercial banks 14, 16; and settlement process 10 may utilize a third smart contract (e.g., smart contract 56) to monitor and/or process asset transfers (e.g., asset transfers 46, 48) between commercial banks 16, 12.

For this example and when a single multi-party smart contract (e.g., smart contract 58) is utilized, settlement process 10 may utilize a single smart contract (e.g., smart contract 58) to monitor 100 all asset transfers (e.g., asset transfers 38, 40, 42, 44, 46, 48) between all commercial banks (e.g., commercial banks 12, 14, 16).

### Smart Contract Modification & Replacement

As discussed above, settlement process 10 may administer 112 the one or more smart contracts (e.g., smart contracts 52, 54, 56, 58), wherein administering 112 the one or more smart contracts (e.g., smart contracts 52, 54, 56, 58) may include modifying 114 the one or more smart contracts (e.g., smart contracts 52, 54, 56, 58) in a minor/major fashion.

For example, the one or more smart contracts (e.g., smart contracts 52, 54, 56, 58) may include code and/or variables (not shown) that may define one or more discrete aspects of the smart contract(s). Therefore and when modifying 114 the one or more smart contracts (e.g., smart contracts 52, 54, 56, 58), settlement process 10 may modify the code and/or variables (not shown) included within the one or more smart contracts (e.g., smart contracts 52, 54, 56, 58). When modifying 114 the one or more smart contracts (e.g., smart contracts 52, 54, 56, 58), settlement process 10 may perform the modification locally (e.g., where the smart contracts are stored) or may perform the modification remotely and the modified smart contracts may be pushed (by settlement process 10) to e.g., where the smart contracts are stored.

Additionally/alternatively and when administering 112 the one or more smart contracts (e.g., smart contracts 52, 54, 56, 58), settlement process 10 may choose to replace 116 the one or more smart contracts (e.g., smart contracts 52, 54, 56, 58). Accordingly, assume that being the one or more smart contracts (e.g., smart contracts 52, 54, 56, 58) need to be extensively modified, settlement process 10 may simply replace 116 the one or more smart contracts (e.g., smart contracts 52, 54, 56, 58) in its entirety. When replacing 116 the one or more smart contracts (e.g., smart contracts 52, 54, 56, 58), settlement process 10 may replace the smart contract locally (e.g., where the smart contracts are stored) or may replace the smart contract remotely and the replacement smart contract may be pushed (by settlement process 10) to e.g., where the smart contracts are stored.

Replacing 116 the one or more smart contracts (e.g., smart contracts 52, 54, 56, 58) may include replacing 118 the one or more smart contracts (e.g., smart contracts 52, 54, 56, 58) with a “successor” smart contract.

As discussed above, the above-described system may utilize at least one distributed ledger (e.g., ledger 60, ledger 62, ledger 64 and/or ledger 66), wherein settlement process 10 may update 106 the at least one distributed ledger (e.g., ledger 60, ledger 62, ledger 64 and/or ledger 66) to memorialize the settlement of asset transfers (e.g., asset transfers 38, 40, 42, 44, 46, 48). Since these asset transfers (e.g., asset transfers 38, 40, 42, 44, 46, 48) may be effectuated via one or more smart contracts (e.g., smart contracts 52, 54, 56, 58), some of the data defined within these distributed ledgers (e.g., ledger 60, ledger 62, ledger 64 and/or ledger 66) may concern the execution of the one or more smart contracts (e.g., smart contracts 52, 54, 56, 58).

Typically, the data associated with a smart contract (e.g., smart contracts 52, 54, 56, 58) is only accessible to that specific smart contract. Accordingly and when one or more smart contracts (e.g., smart contracts 52, 54, 56, 58) are replaced, the data associated with the “replaced” smart contract may not be accessible to the “successor” smart contract. Therefore and to avoid the loss of such historical data, settlement process 10 may be configured to maintain the “bloodline” of a smart contract so that successor smart contracts have access to the data associated with replaced smart contracts.

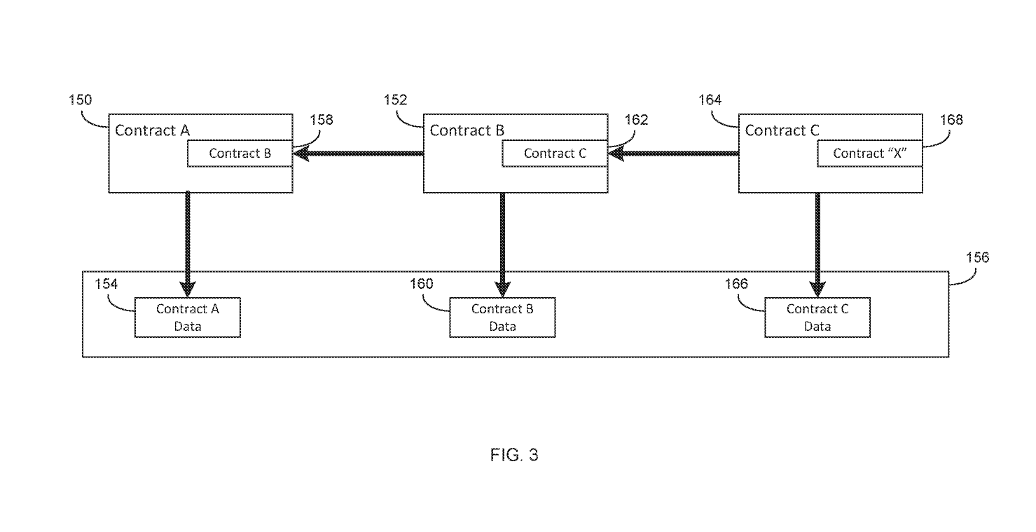

Accordingly and referring also to FIG. 3, assume that smart contract 150 (e.g., chosen from smart contracts 52, 54, 56, 58) is going to be replaced with a “successor” smart contract (e.g., smart contract 152). Further, assume that smart contract data 154 is associated with smart contract 150. Smart contract data 154 may be stored within distributed ledger 156 (e.g., chosen from ledgers 60, 62, 64, 66). Alternatively, smart contract data 154 may be stored in a manner that does not involve a distributed ledger.

Continuing with the above-stated example, settlement process 10 may replace 118 a select contract (e.g. smart contract 150), chosen from the one or more smart contracts (e.g., smart contracts 52, 54, 56, 58), with a successor contract (e.g., smart contract 152). As discussed above, the data associated with a smart contract is typically only accessible to the specific smart contract with which the data is associated. Therefore, access to smart contract data 154 may be restricted and may only be accessed by (in this example) smart contract 150. Accordingly and in order to maintain the “bloodline” and to maintain access to smart contract data 154, settlement process 10 may grant 120 access to data (e.g., smart contract data 154) associated with the select contract (e.g. smart contract 150) to the successor contract (e.g. smart contract 152).

Specifically, when a smart contract is initially generated, a “successor” field may be defined within the smart contract that may be populated in the future to identify a successor contract (in the event that the newly-created smart contract is replaced sometime in the future). Accordingly and when smart contract 150 was initially generated, successor field 158 would have been defined within smart contract 150 so that successor field 158 may be populated to define a successor contract in the event that (in this case) smart contract 150 is subsequently replaced. Accordingly and when settlement process 10 grants 120 access to the data (e.g., smart contract data 154) associated with the select contract (e.g. smart contract 150) to the successor contract (e.g. smart contract 152), settlement process 10 may populate successor field 158 within smart contract 150 to identity the successor smart contract (i.e., smart contract 152).

As the above-describe system uses a distributed ledger, each of the interested parties associated with the smart contract in question (e.g., two or more of commercial banks 12, 14, 16 and central bank 18) must approve the replacement of the smart contract in question and/or the subsequent population of the successor field included therein.

Continuing with the above-stated example and during the use of the successor contract (e.g. smart contract 152), smart contract 152 may generate data (i.e., smart contract data 160), wherein smart contract data 160 may be stored within distributed ledger 156 (e.g., chosen from ledgers 60, 62, 64, 66) or may be stored in a manner that does not involve a distributed ledger. Access to smart contract data 160 may be restricted and may only be accessed by (in this example) by smart contract 152. Additionally, if smart contract 152 (or users thereof) need to access smart contract data 154 (i.e., the smart contract data that is associated with smart contract 150), smart contract 152 may access smart contract data 154 via smart contract 150 (e.g., using smart contract 150 as a proxy) since successor field 158 within smart contract 150 defines smart contract 152 as the “successor” of smart contract 150.

As discussed above, when smart contract 152 is initially generated, a “successor” field (e.g., successor field 162) may be defined within smart contract 152 that may be populated in the future to identify a successor contract in the event that the newly-created smart contract (e.g., smart contract 152) is replaced sometime in the future). Assume that (for various reasons) smart contract 152 needs to be replaced. Accordingly, settlement process 10 may replace 122 the successor contract (e.g., smart contract 152) with a subsequent contract (e.g., subsequent contract 164) and settlement process 10 may grant 124 access to the data (e.g., smart contract data 160) associated with the successor contract (e.g., smart contract 152) to the subsequent contract (subsequent contract 164). When settlement process 10 grants 124 access to the data (e.g., smart contract data 160) associated with the successor contract (e.g. smart contract 152) to the subsequent contract (e.g. smart contract 164), settlement process 10 may populate successor field 162 within smart contract 152 to identity the subsequent smart contract (i.e., smart contract 164).

Again, as the above-describe system uses a distributed ledger, each of the interested parties associated with the smart contract in question (e.g., two or more of commercial banks 12, 14, 16 and central bank 18) must approve the replacement of the smart contract in question and/or the subsequent population of the successor field included therein.

Continuing with the above-stated example and during the use of the subsequent contract (e.g. smart contract 164), smart contract 164 may generate data (i.e., smart contract data 166), wherein smart contract data 166 may be stored within distributed ledger 156 (e.g., chosen from ledgers 60, 62, 64, 66) or may be stored in a manner that does not involve a distributed ledger. Access to smart contract data 166 may be restricted and may only be accessed by (in this example) smart contract 164. Additionally, if smart contract 164 (or users thereof) need to access smart contract data 160 (i.e., the smart contract data that is associated with smart contract 152), smart contract 164 may access smart contract data 160 via smart contract 152 (e.g., using smart contract 152 as a proxy) since successor field 162 within smart contract 152 defines smart contract 164 as the “successor” of smart contract 152. Further, if smart contract 164 (or users thereof) need to access smart contract data 154 (i.e., the smart contract data that is associated with smart contract 150), smart contract 164 may access smart contract data 154 via the combination of smart contract 152 and smart contract 150, since successor field 162 within smart contract 152 defines smart contract 164 as the “successor” of smart contract 152 and successor field 158 within smart contract 150 defines smart contract 152 as the “successor” of smart contract 150.

In the manner described above, when smart contract 164 is initially generated, a “successor” field (e.g., successor field 168) may be defined within smart contract 164 that may be populated in the future to identify a successor contract in the event that the newly-created smart contract (e.g., smart contract 164) is replaced sometime in the future). Accordingly, the manner in which successor fields (e.g., successor fields 158, 162, 168) are used to access the data associated with a replaced smart contract may be expanded/repeated/continued to cover as many layers of smart contracts as needed.

Additionally, the above-described system may be enhanced through the use of various privacy-enhancing technologies. Examples of such privacy-enhancing technologies may include but are not limited to Intel tm SGX tm technology, which may enable smart contracts to contain secrets that are secured through the use of segregated hardware and memory. This, in turn, may allow these smart contracts to function as gatekeepers of data since they may be the only devices capable of decrypting such encrypted data As is known in the art, Intel tm SGX tm is a set of central processing unit (CPU) instruction codes from Intel tm that allow user-level code to allocate private regions of memory (called enclaves) that are protected from processes running at higher privilege levels. Intel designed SGX to be useful for implementing secure remote computation, secure web browsing, and digital rights management.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method for effectuating one or more asset transfers, executed on a computing device, comprising:
defining one or more smart contracts between various member banks associated with a central bank,
replacing a select contract, chosen from the one or more smart contracts, with a successor contract; and
granting access to data associated with the select contract to the successor contract.

2. The computer implemented method of claim 1 wherein the one or more smart contracts includes a plurality of two-party smart contracts between unique pairs of the various member banks.

3. The computer implemented method of claim 1 wherein the one or more smart contracts includes a single multi-party smart contract between all of the various member banks.

4. The computer implemented method of claim 1 further comprising:
processing one or more asset transfers between the various member banks associated with the central bank.

5. The computer implemented method of claim 4 further comprising:
settling the one or more asset transfers.

6. The computer implemented method of claim 5 wherein settling the one or more asset transfers includes:
updating at least one distributed ledger to memorialize the settlement of the one or more asset transfers via the central bank.

7. The computer implemented method of claim 6 wherein the at least one distributed ledger includes a blockchain ledger.

8. The computer implemented method of claim 6 wherein updating at least one distributed ledger to memorialize the settlement of the one or more asset transfers via the central bank includes:
updating a distributed ledger associated with each of the various member banks to memorialize the settlement of the one or more asset transfers via the central bank.

9. The computer implemented method of claim 1 further comprising:
replacing the successor contract with a subsequent contract.

10. The computer implemented method of claim 9 further comprising:
granting access to data associated with the successor contract to the subsequent contract.

11. A computer program product residing on a computer readable medium having a plurality of instructions stored thereon which, when executed by a processor, cause the processor to perform operations comprising:
defining one or more smart contracts between various member banks associated with a central bank,
replacing a select contract, chosen from the one or more smart contracts, with a successor contract;
granting access to data associated with the select contract to the successor contract; and
processing one or more asset transfers between the various member banks associated with the central bank.

12. The computer program product of claim 11 wherein the one or more smart contracts includes a plurality of two-party smart contracts between unique pairs of the various member banks.

13. The computer program product of claim 11 wherein the one or more smart contracts includes a single multi-party smart contract between all of the various member banks.

14. The computer program product of claim 11 further comprising:
processing one or more asset transfers between the various member banks associated with the central bank.

15. The computer program product of claim 14 further comprising:
settling the one or more asset transfers.

16. The computer program product of claim 15 wherein settling the one or more asset transfers includes:
updating at least one distributed ledger to memorialize the settlement of the one or more asset transfers via the central bank.

17. The computer program product of claim 16 wherein the at least one distributed ledger includes a blockchain ledger.

18. The computer program product of claim 16 wherein updating at least one distributed ledger to memorialize the settlement of the one or more asset transfers via the central bank includes:
updating a distributed ledger associated with each of the various member banks to memorialize the settlement of the one or more asset transfers via the central bank.

19. The computer program product of claim 11 further comprising:
replacing the successor contract with a subsequent contract.

20. The computer program product of claim 19 further comprising:
granting access to data associated with the successor contract to the subsequent contract.

21. A computing system including a processor and memory configured to perform operations comprising:
defining one or more smart contracts between various member banks associated with a central bank,
replacing a select contract, chosen from the one or more smart contracts, with a successor contract;
granting access to data associated with the select contract to the successor contract; and
processing one or more asset transfers between the various member banks associated with the central bank.

22. The computing system of claim 21 wherein the one or more smart contracts includes a plurality of two-party smart contracts between unique pairs of the various member banks.

23. The computing system of claim 21 wherein the one or more smart contracts includes a single multi-party smart contract between all of the various member banks.

24. The computing system of claim 21 further comprising:
processing one or more asset transfers between the various member banks associated with the central bank.

25. The computing system of claim 24 further comprising:
settling the one or more asset transfers.

26. The computing system of claim 25 wherein settling the one or more asset transfers includes:
updating at least one distributed ledger to memorialize the settlement of the one or more asset transfers via the central bank.

27. The computing system of claim 26 wherein the at least one distributed ledger includes a blockchain ledger.

28. The computing system of claim 26 wherein updating at least one distributed ledger to memorialize the settlement of the one or more asset transfers via the central bank includes:
updating a distributed ledger associated with each of the various member banks to memorialize the settlement of the one or more asset transfers via the central bank.

29. The computing system of claim 21 further comprising:
replacing the successor contract with a subsequent contract.

30. The computing system of claim 29 further comprising:
granting access to data associated with the successor contract to the subsequent contract.
